(19) United States
(12) Patent Application Publication
(10) Pub. No.: US 2004/0102975 A1
(43) Pub. Date: May 27, 2004

(54) Method and apparatus for masking unnatural phenomena in synthetic speech using a simulated environmental effect

(75) Inventor: Ellen Marie Eide, New York, NY (US)

Correspondence Address: Ryan, Mason & Lewis, LLP, Suite 205, 1300 Post Road, Fairfield, CT, 06430, US

(73) Assignee: International Business Machines Corporation, Armonk, NY (US)

(21) Appl. No.: 10/304,571

(22) Filed: Nov. 26, 2002

(51) Int. Cl. G10L 13/00

(52) U.S. Cl. 704/258

(57) ABSTRACT

A speech synthesis system is disclosed that masks any unnatural phenomena in the synthetic speech. A disclosed environmental effect processor manipulates the background environment into which the synthesized speech is embedded to thereby mask any unnatural phenomena in the synthesized speech. The environmental effect processor can manipulate the background environment, for example, by (i) adding a low level of background noise to the synthesized speech; (ii) superimposing the synthetic speech on a music waveform; or (iii) adding reverberation to the synthesized signal. The speech segments can be recorded in a quiet environment, and the background environment is manipulated in accordance with the present invention at the time of synthesis.

### FIELD OF THE INVENTION

The present invention relates generally to speech synthesis systems and, more particularly, to methods and apparatus that mask unnatural phenomena in synthesized speech.

### BACKGROUND OF THE INVENTION

Speech synthesis techniques generate speech-like waveforms from textual words or symbols. Speech synthesis systems have been used for various applications, including speech-to-speech translation applications, where a spoken phrase is translated from a source language into one or more target languages. In a speech-to-speech translation application, a speech recognition system translates the acoustic signal into a computer-readable format, and the speech synthesis system reproduces the spoken phrase in the desired language.

FIG. 1 is a schematic block diagram illustrating a typical conventional speech synthesis system 100. As shown in FIG. 1, the speech synthesis system 100 includes a text analyzer 110 and a speech generator 120. The text analyzer 110 analyzes input text and generates a symbolic representation 115 containing linguistic information required by the speech generator 120, such as phonemes, word pronunciations, phrase boundaries, relative word emphasis, and pitch patterns. The speech generator 120 produces the speech waveform 130. For a general discussion of speech synthesis principles, see, for example, S. R. Hertz, “The Technology of Text-to-Speech,” Speech Technology, 18-21 (April/May, 1997), incorporated by reference herein.

There are two basic approaches for producing synthetic speech, namely, “formant” and “concatenative” speech synthesis techniques. In a “formant” speech synthesis system, a model of the human speech-production system is maintained. The human vocal tract is simulated by a digital filter which is excited by a periodic signal in the case of voiced sounds and by a noise source in the case of unvoiced sounds. A given speech sound is produced by using a set of parameters that result in an output sound that matches the natural sound as closely as possible. When two adjacent sounds are to be produced, the model parameters are interpolated from the configuration appropriate for the first sound to that appropriate for the second sound. The resulting output speech is therefore smoothly varying, with no abrupt spectral changes. However, the output can sound artificial due to incomplete modeling of the vocal tract and excitation.

In a “concatenative” speech synthesis system, a database of natural speech is maintained. Stored segments of human speech are typically retrieved from the database so as to minimize a cost function, and concatenated to form the output speech. Segments which were not originally contiguous in the database may be joined. When an utterance is synthesized by the speech generator 120, the corresponding speech segments are typically retrieved, concatenated, and modified to reflect prosodic properties of the utterance, such as intonation and duration. While currently available concatenative text-to-speech systems can often achieve very high quality synthetic speech, text to be synthesized occasionally contains one or more “bad splices,” or joins of adjacent segments that contain audible spectral or pitch discontinuities. The discontinuities tend to be localized in time. Spectral discontinuities, for example, can sound like a “pop” or a “click” inserted into the speech at segment boundaries. Pitch discontinuities can sound like a warble or tremble. Both types of discontinuities make the synthetic speech sound unnatural, thereby degrading the perceived quality of the synthesized speech.

The database of segments used in concatenative text-to-speech systems is typically recorded in a completely quiet environment. This quiet background is necessary to avoid a change in background from being evident when two segments having different backgrounds are joined. Unfortunately, the extremely quiet background of the recorded speech allows any discontinuities present in the synthetic speech to be readily perceived.

Both formant and concatenative systems may suffer from inappropriate durations of the individual sounds. These timing errors, along with poor sound quality from formant synthesizers and spectral and pitch discontinuities from concatenative synthesizers, introduce unnaturalness into the synthesizer output. A need therefore exists for a method and apparatus for masking any unnatural phenomena in the synthetic speech.

### SUMMARY OF THE INVENTION

Generally, the present invention provides a speech synthesis system that masks any unnatural phenomena in the synthetic speech generated by a formant or a concatentive speech synthesis system. A disclosed environmental effect processor manipulates the background environment into which the synthesized speech is embedded to thereby mask any unnatural phenomena in the synthesized speech. The environmental effect processor can manipulate the background environment, for example, by (i) adding a low level of background noise to the synthesized speech; (ii) superimposing the synthetic speech on a music waveform; or (iii) adding reverberation to the synthesized signal. In a concatenative synthesizer, the speech segments are recorded in a quiet environment, and the background environment is manipulated in accordance with the present invention at the time of synthesis. Similarly, in a formant synthesizer, the synthetic speech is produced first against a quiet background, and then the background is manipulated to reduce the prominence of unnatural qualities in the speech. The present invention can improve both the potentially unnatural sound quality and unnatural durations of a formant synthesizer, as well as the discontinuities as well and unnatural durations of a concatenative synthesizer. In one variation, the environmental effect processor manipulates the background based on properties of the synthesized speech.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a conventional speech synthesis system;

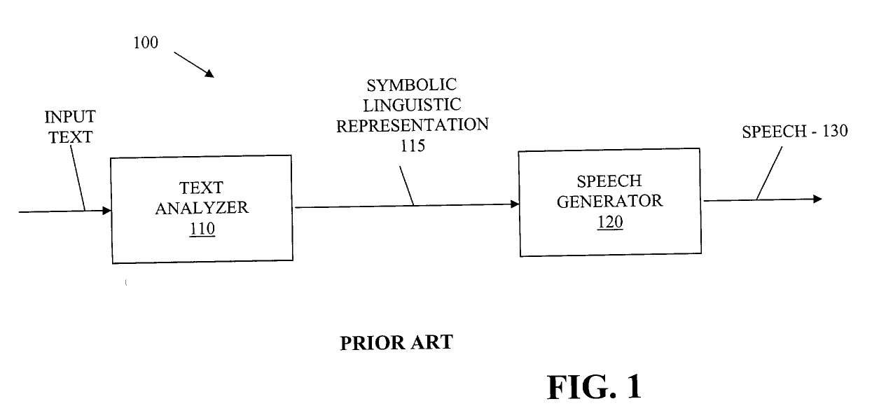

FIG. 2 is a schematic block diagram of a speech synthesis system in accordance with the present invention; and

FIG. 3 is a flow chart describing an exemplary concatenative text-to-speech synthesis system incorporating features of the present invention.

### DETAILED DESCRIPTION OF PREFERRED EMBODIMENTS

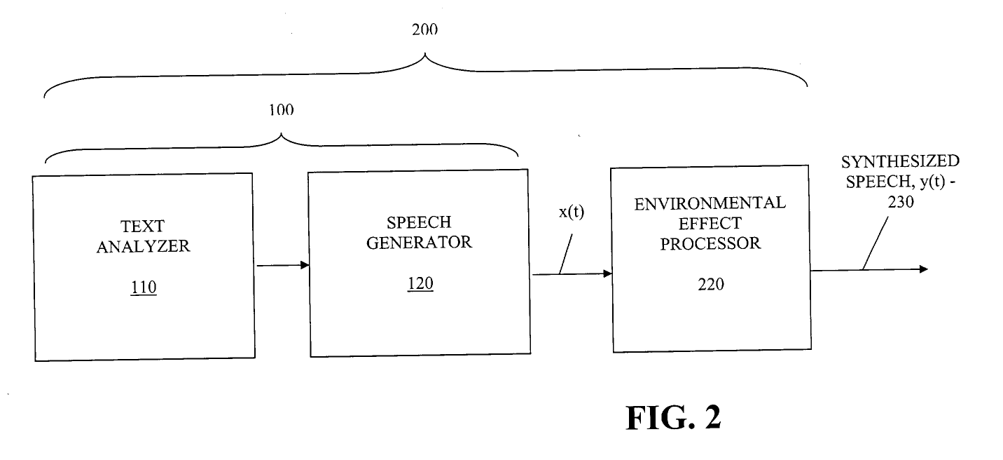

FIG. 2 is a schematic block diagram illustrating a speech synthesis system 200 in accordance with the present invention. As shown in FIG. 2, the speech synthesis system 200 includes the conventional speech synthesis system 100, discussed above, as well as an environmental effect processor 220. The conventional speech synthesis system 100 may be embodied as the formant system ETI-Eloquence 5.0, commercially available from Eloquent Technology, Inc. of Ithaca, N.Y., or as the concatenative speech synthesis system described in R. E. Donovan et al., “Current Status of the IBM Trainable Speech Synthesis System,” Proc. Of 4^{th} ISCA Tutorial and Research Workshop on Speech Synthesis, Scotland (2001), as modified herein to provide the features and functions of the present invention.

According to a feature of the present invention, the environmental effect processor 220 manipulates the background environment into which the synthesized speech is embedded to thereby mask any unnatural phenomena in the synthesized speech. The speech segments are still recorded in a quiet environment, and the background environment is manipulated in accordance with the present invention at the time of synthesis. In one exemplary embodiment, the environmental effect processor 220 manipulates the background into which the speech is embedded by adding a low level of background noise to the synthesized speech. In this manner, the listener has the impression that the speaker is addressing him or her from a large, crowded room. In another variation, the environmental effect processor 220 superimposes the synthetic speech on a music waveform.

In yet another variation, the environmental effect processor 220 manipulates the background to give a listener the feeling that the speaker is in an echoic room by adding reverberation to the signal. As used herein, reverberation occurs when multiple copies of the same signal having various delay intervals reach the listener. Reverberation can be added to the synthesized speech, for example, by adding delayed, attenuated or possibly inverted versions of the synthetic speech to the original synthetic output. This simulates the effect of having the speech bounce off walls. The indirect path(s) reach the listener after some delay, relative to the direct path and the walls absorb some of the signal, causing attenuation. For a more detailed discussion for various techniques for adding reverberation to a signal, see, for example, F. A. Baltran et al., “Matlab Implementation of Reverberation Algorithms,” downloadable from http://www.tele.ntnu.no/akustikk/meetings/DAFx99/beltran.pdf.

The environmental effect processor 220 can also manipulate the background based on properties of the synthesized speech. For example, a percussive sound (drums) can be added to synthesized speech having “clicking” sounds as might arise in a concatenative synthesizer. In addition, the multi-path nature of reverberation may be particularly well-suited to mask durational problems in the synthesized speech of either a formant or a concatenative system.

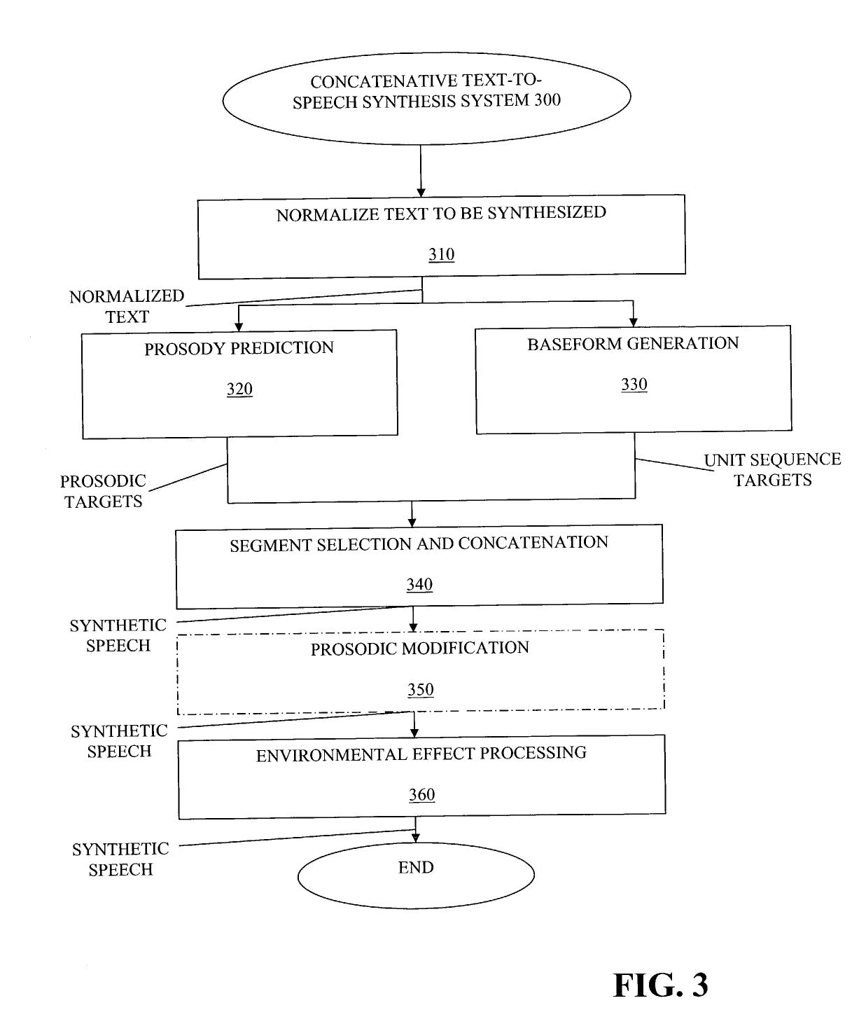

FIG. 3 is a flow chart describing an exemplary implementation of a concatenative text-to-speech synthesis system 300 incorporating features of the present invention. As shown in FIG. 3, the text to be synthesized is normalized during step 310. The normalized text is applied to a prosody predictor during step 320 and a baseform generator during step 330. Generally, the prosody module generates prosodic targets including pitch, duration and energy targets, during step 320. The baseform generator generates unit sequence targets during step 330.

Thereafter, the prosodic and unit sequence targets are processed during step 340 by a back-end that searches a large database to select segments that minimize a cost function and concatenates the selected segments. Thereafter, optional signal processing, such as prosodic modification, is performed on the synthesized speech during step 350.

Finally, the environmental effect processor 220 manipulates the background environment into which the synthesized speech is embedded during step 360 in accordance with the present invention to thereby mask any unnatural phenomena in the synthesized speech. In this manner, the simulation of background environment takes place after the synthetic speech is computed in a quiet environment. As indicated above, the background environment manipulation can, for example, (i) add a low level of background noise to the synthesized speech; (ii) superimpose the synthetic speech on a music waveform; or (iii) add reverberation to the synthesized signal.

The present invention can manipulate the background environment in various ways to mask the unnatural phenomena in the synthesized speech. In one implementation, reverberation is added to the synthesized speech, for example, by adding delayed, attenuated or possibly inverted versions of the synthetic speech to the original synthetic output to simulate the effect of having the speech bounce off walls. The indirect path(s) reach the listener after some delay, relative to the direct path and the walls absorb some of the signal, causing attenuation. Mathematically, the simulated reverberation, y(t), can be expressed as follows:

y[t]=−0.1*x[t−a]+0.05*x[t−b]+−0.025*x[t−c]+0.005*x[t−d]+−0.002*x[t−e].

where each term corresponds to different delayed versions of the synthesized signal and the coefficient for each term indicates how much energy the associated delayed version has. For example, a can equal 1/80 sec, b can equal 1/18.65 sec, c can equal 1/8.59 sec, d can equal 1/3.98 sec, and e can equal ½ sec.

The number of terms, as well as the delays and coefficients in the above formula were determined experimentally. Other values which produce a similar effect are included within the scope of the present invention, as would be apparent to a person of ordinary skill in the art.

It is to be understood that the embodiments and variations shown and described herein are merely illustrative of the principles of this invention and that various modifications may be implemented by those skilled in the art without departing from the scope and spirit of the invention.

What is claimed is:

1. A method for synthesizing speech, comprising:
generating a synthesized speech signal; and
manipulating a background environment into which said synthesized speech signal is embedded.

2. The method of claim 1, wherein said manipulating step further comprises the step of adding background noise to the synthesized speech signal.

3. The method of claim 1, wherein said manipulating step further comprises the step of superimposing said synthetic speech on a music waveform.

4. The method of claim 1, wherein said manipulating step further comprises the step of adding reverberation to the synthesized speech signal.

5. The method of claim 4, wherein said step of adding reverberation to the synthesized speech signal further comprises the step of adding a delayed version of said synthesized speech signal.

6. The method of claim 4, wherein said step of adding reverberation to the synthesized speech signal further comprises the step of adding an attenuated version of said synthesized speech signal.

7. The method of claim 4, wherein said step of adding reverberation to the synthesized speech signal further comprises the step of adding an inverted version of said synthesized speech signal.

8. The method of claim 1, wherein said synthesized speech signal is generated by a concatenative speech synthesis system from concatenated speech segments.

9. The method of claim 8, wherein said concatenated speech segments are recorded in a quiet environment.

10. The method of claim 1, wherein said manipulating step further comprises the step of manipulating said background environment based on properties of said synthesized speech signal.

11. The method of claim 1, wherein said synthesized speech signal is generated by a formant speech synthesis system.

12. A speech synthesizer, comprising:
a speech synthesis module for generating a synthesized speech signal; and
an environmental effect processor that manipulates a background environment into which said synthesized speech signal is embedded.

13. The speech synthesizer of claim 12, wherein said environmental effect processor is further configured to add background noise to the synthesized speech signal.

14. The speech synthesizer of claim 12, wherein said environmental effect processor is further configured to superimpose said synthetic speech on a music waveform.

15. The speech synthesizer of claim 12, wherein said environmental effect processor is further configured to add reverberation to the synthesized speech signal.

16. The speech synthesizer of claim 15, wherein said environmental effect processor is further configured to add a delayed version of said synthesized speech signal.

17. The speech synthesizer of claim 15, wherein said environmental effect processor is further configured to add an attenuated version of said synthesized speech signal.

18. The speech synthesizer of claim 15, wherein said environmental effect processor is further configured to add an inverted version of said synthesized speech signal.

19. The speech synthesizer of claim 12, wherein said speech synthesis module is a concatenative speech synthesis system that generates said synthesized speech signal from concatenated speech segments.

20. The speech synthesizer of claim 19, wherein said concatenated speech segments are recorded in a quiet environment.

21. The speech synthesizer of claim 12, wherein said environmental effect processor manipulates said background environment based on properties of said synthesized speech signal.

22. The speech synthesizer of claim 12, wherein said speech synthesis module is a formant speech synthesis system.

23. A method for synthesizing speech, comprising:
generating a synthesized speech signal; and
manipulating a background environment into which said synthesized speech signal is embedded based on properties of said synthesized speech signal.
